(19) United States
(12) Patent Application Publication
(10) Pub. No.: US 2014/0218942 A1
(43) Pub. Date: Aug. 7, 2014

(54) COOLING STRUCTURE FOR LED LIGHTING DEVICE AND LIGHT EMITTING MODULE HAVING THE SAME

(71) Applicant: APACK, Inc., Daejeon (KR)

(72) Inventors: Kyu Seop SONG, Daejeon (KR); Kwang Soo KIM, Daejeon (KR); Young Hoon AN, Sejong (KR); Hyeon Uk HAM, Daejeon (KR)

(21) Appl. No.: 13/938,505

(22) Filed: Jul. 10, 2013

(30) Foreign Application Priority Data
Feb. 6, 2013 (KR) 10-2013-0013461

(51) Int. Cl. F21V 29/00

(52) U.S. Cl. CPC F21V 29/22
USPC 362/382

(57) ABSTRACT

Provided are a cooling structure for an LED lighting device and a light emitting module having the same. The cooling structure for an LED lighting device according to the present invention has a structure in which an LED module is disposed in a tray-shaped heat sink coupled with a lower portion of a lighting box having an LED module disposed therein to block the lower portion of the lighting box and perforated with a ventilation hole to make external air flow therein, thereby discharging heat generated from the LED module through the heat sink. Therefore, the cooling structure for an LED lighting device can have excellent cooling efficiency and can be implemented as an LED lighting device by minimizing the replacement of components of the existing metal lamp lighting device.

### CROSS-REFERENCE TO RELATED APPLICATIONS

This application claims priority under 35 U.S.C. §119 to Korean Patent Application No. 10-2013-0013461, filed on Feb. 6, 2013, in the Korean Intellectual Property Office, the disclosure of which is incorporated herein by reference in its entirety.

### TECHNICAL FIELD

The present invention relates to a cooling structure for an LED lighting device for preventing energy efficiency and luminous efficiency from deteriorating by rapidly discharging heat generated from an LED which is a light emitting unit.

### BACKGROUND

In general, an LED (light emitting diode) is a photoelectronic device which has a junction structure of P type and N type semiconductors and emits light of energy corresponding to a bandgap of a semiconductor by combining electrons and holes when being applied with power.

Since the LED has a reaction time faster than that a general bulb and power consumption 20% smaller than that of a general bulb, the LED has been widely used as a high-efficiency lighting device.

In recent, an LED lighting device using an LED as a light emitting unit for a lighting device, such as a street light, a flood light installed in a parking lot, or the like, has also been commercialized.

Korean Patent No. 10-0974942, and the like, has proposed a structure of an LED street light which is a kind of lighting device.

However, the LED generates very high heat at the time of emitting light and degrades the luminous efficiency and the energy efficiency when the heat is accumulated.

In particular, since a high-output LED used in a lighting device outputs very high heat to be rapidly heated, there is a need to reduce the generation of heat by fast cooling.

The LED lighting device according to the related art has adopted a cooling structure for preventing the LED from being in a high temperature state by rapidly discharging heat generated from the LED.

However, the cooling structure of the LED lighting device according to the related art has a structure in which an LED module 1 having an LED disposed therein to simply emit light is disposed within a lighting box and a heat sink 2 for cooling is disposed on the LED module 1.

Further, the heat sink 2 is exposed to the outside.

Therefore, the cooling structure included in the lighting device according to the related art may not reach the expected cooling effect and has the degraded cooling effect due to foreign matters collected between radiation fins of the heat sink 2 with the passage of time.

Further, a lighting device, such as street light, is often turned on from the early evening. This cause the LED to emit light in the state in which the heat sink 2 included in the LED lighting device is heated at a considerably high temperature by sunlight during the daytime, such that the LED may not reach the expected luminous efficiency and energy efficiency.

Meanwhile, when the existing metal lamp lighting device is replaced with the LED lighting device, there is a need to replace most components other than a pillar and an arm, which may cause considerable costs and thus increase an economic burden.

Further, when only the metal lamp is simply replaced with the LED module, the cooling efficiency is very low, such that the LED may not reach the expected efficiency.

### Related Art Document

### Patent Document

(Patent Document 1) Korean Patent No. 10-0974942

### SUMMARY

An exemplary embodiment of the present invention is directed to providing a cooling structure for an LED lighting device having excellent cooling efficiency and excellent luminous efficiency and energy efficiency and capable of being implemented as an LED lighting device by minimizing the replacement of components of the existing lighting device, and a light emitting module having the same.

In one general aspect, there is provided a light emitting module for an LED lighting device having a cooling structure in which an LED module is disposed in a tray-shaped (container shape having a plurality of holes) heat sink coupled with a lower portion of a lighting box to block the lower portion of the lighting box, thereby having excellent cooling efficiency and being implemented as an LED lighting device by minimizing the replacement of components of the existing lighting device.

In another general aspect, there is provided a cooling structure for an LED lighting device in which an LED module is disposed in a tray-shaped heat sink coupled with a lower portion of a lighting box to block the lower portion of the lighting box and perforated with a ventilation hole to make external air flow therein, thereby discharging heat generated from the LED module through the heat sink.

### BRIEF DESCRIPTION OF THE DRAWINGS

FIG. 1 is a schematic diagram for describing an LED street light according to the related art.

FIG. 2 is a perspective view of a light emitting module according to an exemplary embodiment of the present invention for describing a cooling structure for an LED lighting device according to the exemplary embodiment of the present invention.

FIG. 3 is a perspective view of the light emitting module illustrated in FIG. 2 viewed from below.

FIG. 4 is a cross-sectional view of the light emitting module according to an exemplary embodiment of the present invention for describing the cooling structure for an LED lighting device according to the exemplary embodiment of the present invention.

FIG. 5 is a plan view of the light emitting module according to the exemplary embodiment of the present invention for describing the cooling structure for an LED lighting device according to the exemplary embodiment of the present invention.

FIG. 6 is a schematic diagram for describing a state in which the light emitting module according to the exemplary embodiment of the present invention is coupled with a lighting box.

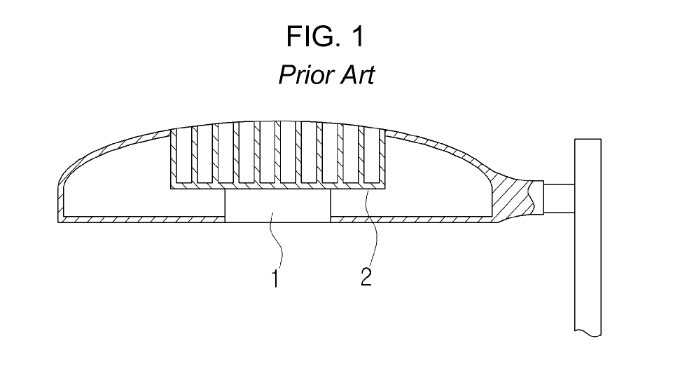

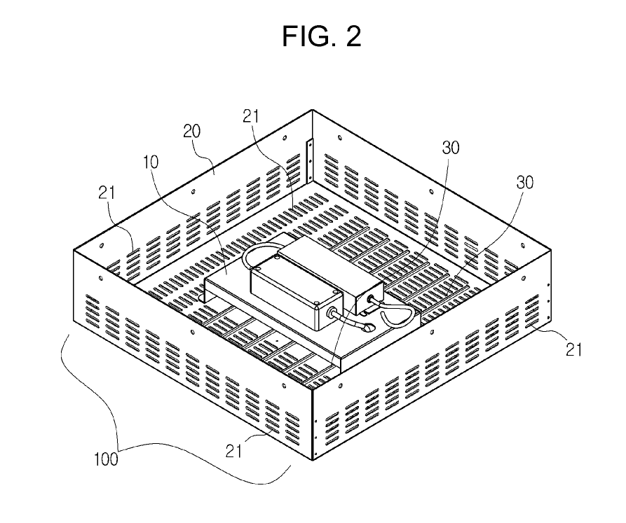

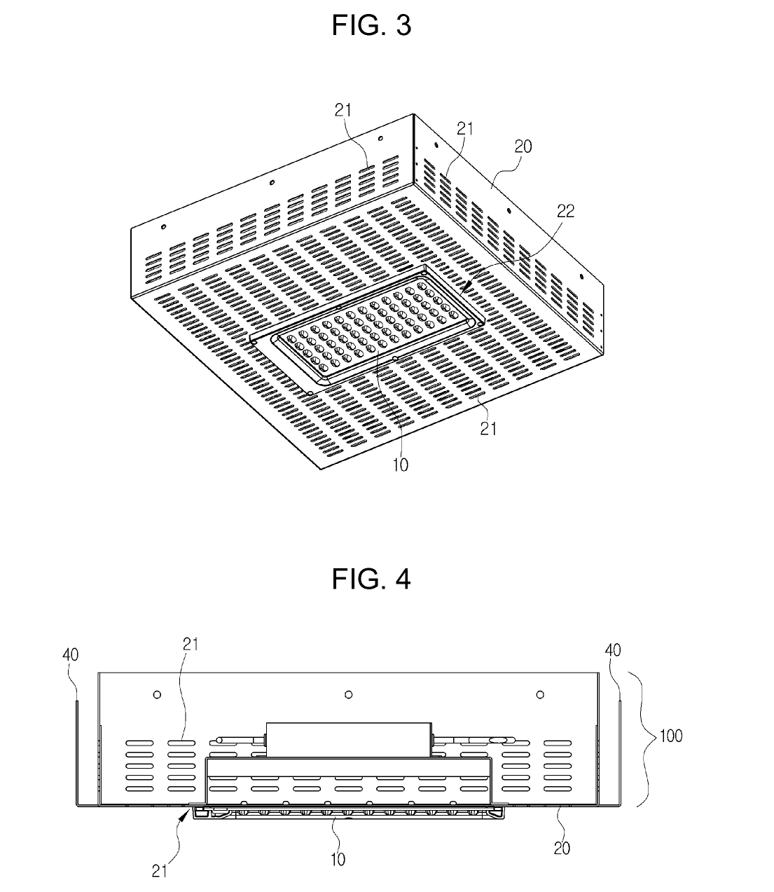

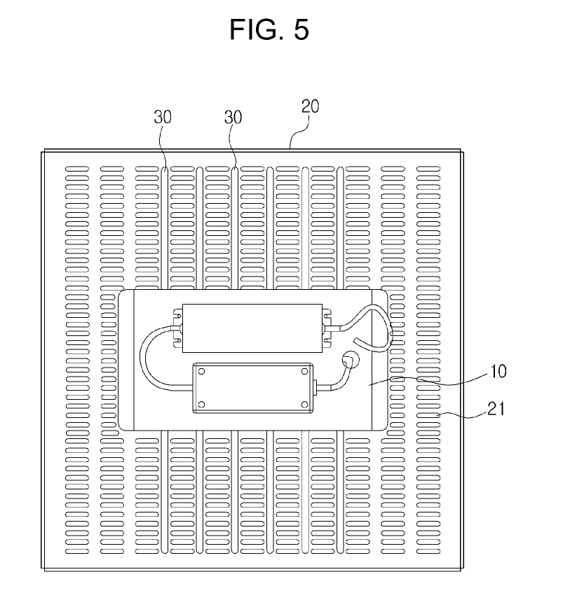

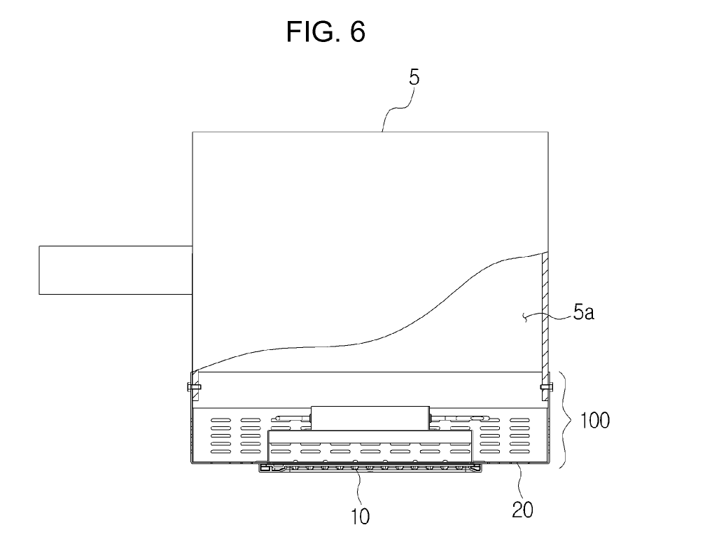

### DETAILED DESCRIPTION OF MAIN ELEMENTS

1: LED MODULE
2: HEAT SINK
5: LIGHTING BOX
5a: INNER SPACE
10: LED MODULE
20: HEAT SINK
21: VENTILATION HOLE
22: LED MODULE INSTALLATION HOLE
30: HEAT CARRIER
40: LIGHT SHIELD

### DETAILED DESCRIPTION OF EMBODIMENTS

Hereinafter, a technical spirit of the present invention will be described in more detail with reference to the accompanying drawings.

However, the accompanying drawings are only examples shown in order to describe the technical idea of the present invention in more detail. Therefore, the technical idea of the present invention is not limited to shapes of the accompanying drawings.

An exemplary embodiment of the present invention relates to a cooling structure for an LED lighting device for discharging heat generated from an LED module which is a component to emit light from the LED lighting device.

Therefore, like the cooling structure for an LED lighting device according to the related art, the heating structure has a heat sink 20 to discharge heat.

Herein, an object of the present invention is to provide a cooling structure for an LED lighting device having excellent cooling efficiency and excellent luminous efficiency and energy efficiency and capable of being implemented as an LED lighting device by minimizing the replacement of components of the existing metal lamp lighting device, and a light emitting module having the same.

To this end, the heat sink 20 according to the exemplary embodiment of the present invention is coupled with a lower portion of a lighting box 5 to block the lower portion of the lighting box 5.

Further, the heat sink 20 has a tray shape in which a ventilation hole 21 is perforated to make external air flow therein.

The heat sink 20 has a cooling structure in which the heat sink 20 has the LED module 10 disposed therein to discharge heat generated from the LED module 10 through the heat sink 20.

The heat sink 20 has a structure in which external air flows in the heat sink 20 through the ventilation hole 21, thereby having excellent cooling efficiency.

Further, since strong sunlight is not continuously irradiated to the heat sink 20 during the summer season, it is possible to prevent the phenomenon that the heat sink 20 is heated at very high temperature till the early evening from which the lighting device starts to be driven by sunlight.

Further, it is possible to prevent the cooling efficiency of the heat sink 20 from deteriorating due to the accumulation of foreign objects included in rain, and the like.

For this reason, it is possible to obtain very excellent cooling efficiency.

Further, the existing lighting device may be replaced with the LED lighting device by replacing only the heat sink 20 and the LED module 10 according to the exemplary embodiment of the present invention after only some components, such as a metal lamp, and the like, within the lighting box 5 is removed without replacing the lighting box 5 of the existing lighting device such as the metal lamp lighting device, thereby providing very excellent economical efficiency.

The heat sink 20 according to the exemplary embodiment of the present invention may be manufactured by a method of bending a perforated plate made of aluminum having excellent heat transfer efficiency, and the like, and therefore may be easily manufactured.

According to the exemplary embodiment of the present invention, in order to make the cooling efficiency of the heat sink 20 more excellent, there is a need to uniformly diffuse the heat generated from the LED module 10 to the heat sink 20 and rapidly diffuse the heat.

To this end, the heat sink 20 may further include a heat carrier 30 which has a portion contacting the LED module 10 or disposed in the vicinity of the LED module 10 and a portion extending toward a direction far away from the LED module 10 to disperse the heat generated from the LED module 10 to several points of the heat sink 20.

The heat carrier 30 is disposed to cross the LED module 10, thereby making the heat transfer efficiency excellent and several heat carriers 30 is preferable to uniformly diffuse heat in the vicinity of the LED module 10 to the heat sink 20.

As the heat carrier 30, a heat pipe, and the like, may be used.

When the ventilation holes 21 formed in the heat sink 20 which is a component according to the exemplary embodiment of the present invention are perforated at left and right, front and rear, and lower portions of the heat sink 20, the excellent cooling efficiency may be obtained.

Further, the ventilation hole 21 may be formed in plural in each direction.

When considering the cooling efficiency, the lighting box 5 may be configured to have an inner space 5a in which the heat generated from the LED module 10 rises upward toward an upper portion of the heat sink 20.

That is, it is possible to prevent the LED module 10 from being heated due to the presence of the space (inner space 5a of the lighting box 5) in the upper portion of the LED module 10.

When the upper portion of the LED module 10 is clogged without the inner space 5a, cooling may not be smoothly performed.

According to the exemplary embodiment of the present invention, the light emitting module 100 in which the LED module 10 for emitting light and the heat sink 20 for cooling are integrated may be manufactured and distributed.

That is, the exemplary embodiment of the present invention configures the light emitting module 100 in which the LED module 10 is disposed in the tray-shaped heat sink 20 coupled with the lower portion of the lighting box 5 to block the lower portion of the lighting box 5 and perforated with the ventilation hole 21 to make external air flow therein.

Meanwhile, the cooling structure according to the exemplary embodiment of the present invention as described above prevents the heat sink 20 from being heated due to the strong sunlight during the summer season.

However, the heat sink 20 is heated by sunlight, and therefore there is a need to prevent the efficiency of the LED lighting device from deteriorating.

That is, sunlight is irradiated to a portion of the heat sink 20 during the summer season in which sunlight is strong and the daytime is long, such that the temperature of the heat sink 20 may rise even at the early evening.

The reason is that the heat sink 20 is made of an aluminum material having the excellent heat transfer efficiency, and the like, and thus may be easily heated by sunlight.

As described above, when the LED module 10 emits light in the early evening in which the heat sink 20 is heated, the energy efficiency is reduced and the lifespan of the LED module 10 is reduced.

Further, when the LED module 10 emits light in the early evening in which the heat sink 20 is heated, the heat sink 20 may be maintained at a high temperature for a long period of time, such that the LED module 10 may have reduced luminous efficiency even in the dark state and thus may not reach the expected luminous performance for a long period of time.

Therefore, there is a need to further prevent the heat sink 20 from being heated due to sunlight.

To this end, a light shield 40 to prevent sunlight from being transferred to the heat sink 20 may be disposed outside the heat sink 20.

However, the light shield 40 needs to be configured not to hinder ventilation or removal of foreign objects and therefore may be configured in a mesh form.

In the accompanying drawing, the LED module 10 has a structure in which it is disposed in an LED module installation hole 22 disposed at a central portion in the heat sink 20 to allow a portion of the LED module 10 to be exposed to the outside.

The structure may directly exchange heat between a portion of the LED module 10 and the external air to improve the cooling effect.

According to the exemplary embodiments of the present invention, the cooling structure can have a structure in which the LED module is disposed in the tray-shaped heat sink coupled with the lower portion of the lighting box to block the lower portion of the lighting box, thereby making the cooling efficiency excellent and implementing the LED lighting device by minimizing the replacement of components of the existing lighting device.

In particular, the external air can flow in the heat sink through the ventilation hole of the heat sink, thereby making the cooling effect excellent.

Further, the heat sink can include the heat carrier which has the portion contacting the LED module or disposed in the vicinity of the LED module and the portion extending toward a direction far away from the LED module to disperse the heat generated from the LED module to several points of the heat sink, thereby making the cooling efficiency more excellent.

The present invention is not limited to the above-mentioned exemplary embodiments but may be variously applied, and may be variously modified by those skilled in the art to which the present invention pertains without departing from the gist of the present invention claimed in the claims.

What is claimed is:

1. A cooling structure for an LED lighting device using an LED module, wherein the LED module is disposed in a tray-shaped heat sink coupled with a lower portion of a lighting box to block the lower portion of the lighting box and perforated with a ventilation hole to make external air flow therein so as to discharge heat generated from the LED module through the heat sink.

2. The cooling structure of claim 1, further comprising:
a heat carrier which has a portion contacting the LED module or disposed in the vicinity of the LED module and a portion extending toward a direction far away from the LED module to disperse heat generated from the LED module to several points of the heat sink.

3. The cooling structure of claim 1, wherein a light shield in a mesh form for preventing sunlight from being transferred to the heat sink is disposed outside the heat sink.

4. The cooling structure of claim 1, wherein the ventilation hole is perforated at left and right, front and rear, and lower portions of the heat sink.

5. The cooling structure of claim 2, wherein the ventilation hole is perforated at left and right, front and rear, and lower portions of the heat sink.

6. The cooling structure of claim 3, wherein the ventilation hole is perforated at left and right, front and rear, and lower portions of the heat sink.

7. The cooling structure of claim 1, wherein the lighting box has an inner space in which the heat generated from the LED module rises up toward an upper portion of the heat sink.

8. The cooling structure of claim 2, wherein the lighting box has an inner space in which the heat generated from the LED module rises up toward an upper portion of the heat sink.

9. The cooling structure of claim 3, wherein the lighting box has an inner space in which the heat generated from the LED module rises up toward an upper portion of the heat sink.

10. An LED lighting device having the cooling structure for an LED lighting device of claim 1.

11. An LED lighting device having the cooling structure for an LED lighting device of claim 2.

12. An LED lighting device having the cooling structure for an LED lighting device of claim 3.

13. A light emitting module having a cooling structure for an LED lighting device, wherein an LED module is disposed in a tray-shaped heat sink coupled with a lower portion of a lighting box to block the lower portion of the lighting box and perforated with a ventilation hole to make external air flow therein so as to discharge heat generated from the LED module through the heat sink.
